(19) United States
(12) Patent Application Publication
(10) Pub. No.: US 2005/0266803 A1
(43) Pub. Date: Dec. 1, 2005

(54) Apparatus and methods for adaptation of signal detection threshold of a WLAN receiver

(76) Inventors: Nati Dinur, Omer (IL); Rony Ross, Tel-Aviv (IL); Boris Ginzburg, Haifa (IL); Moshe Nouh, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/857,314

(22) Filed: Jun. 1, 2004

(51) Int. Cl. H04Q 7/24

(52) U.S. Cl. 455/67.11; 455/67.7

(57) ABSTRACT

A wireless network device may include a receiver having an active energy detection threshold and a processor to control the active energy detection threshold. The processor may determine preferred energy detection thresholds for the receiver for corresponding communication channels to which the receiver is tunable, and may select one of the preferred energy detection thresholds as an active energy detection threshold of the receiver for communication on a corresponding one of the communication channels. While the wireless network device is associated with another wireless network device of a wireless network over a communication channel, the processor may adjust the energy detection threshold of the receiver to changing conditions of the wireless network.

### BACKGROUND OF THE INVENTION

A wireless local area network (WLAN) may be based on a cellular architecture where the system is subdivided into cells. One type of cell, known as a basic service set (BSS), contains stations controlled by an access point (AP), and another type of cell, known as an independent basic service set (IBSS), contains stations which are not controlled by an AP. A non-exhaustive list of such stations includes WLAN routers, WLAN-enabled notebook or laptop computers, WLAN-enabled desktop computers, WLAN-enabled personal digital assistants (PDA), WLAN-enabled cellular phones, WLAN-enabled appliances, and the like. In a BSS, stations may communicate with the AP over respective communication channels. In an IBSS, stations may communicate directly with other stations over communication channels. The access points of different BSSs may be connected via a distribution system (DS). The entire interconnected WLAN including the different cells, their respective access points and the distribution system may be known as an extended service set (ESS).

A BSS or IBSS may conform to a communication standard, such as, for example, ANSI/IEEE standard 802.11 for WLAN Medium Access Control (MAC) and Physical layer (PHY) specifications Rev. g for higher data rate extension in the 2.4 GHz band, published 2003, and may use communication links, defined by at least their carrier frequencies and their spectral mask.

Energies related to signals transmitted over one communication channel may penetrate into the spectral vicinity of other channels. In addition, energies from other sources may penetrate into the spectral vicinity of communication channels used by a particular BSS. Such other sources may be, for example, signals that belong to other basic service sets, signals that belong to other communication systems that do not conform to the same communication standard as the particular BSS, and noise signals, such as background noise and white noise.

Such energies may affect the ability of WLAN devices in the BSS to recognize signals originated from other WLAN devices, to establish communication links among them and to maintain those communication links.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a simplified block-diagram illustration of an exemplary wireless communication system, in accordance with some embodiments of the invention;

FIG. 2 is a simplified flowchart illustration of an exemplary method for dynamic adaptation of active energy detection threshold of a receiver in a WLAN station, according to some embodiments of the invention;

FIG. 3 is a simplified flowchart illustration of an exemplary method for defining minimal and maximal signal recognition thresholds of a receiver in a WLAN station for a communication channel, according to some embodiments of the invention; and

FIG. 4 is a simplified flowchart illustration of an exemplary method for dynamic adaptation of an active energy detection threshold of a receiver in a WLAN station for an associated communication channel, according to some embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, devices and circuits have not been described in detail so as not to obscure the embodiments of the invention.

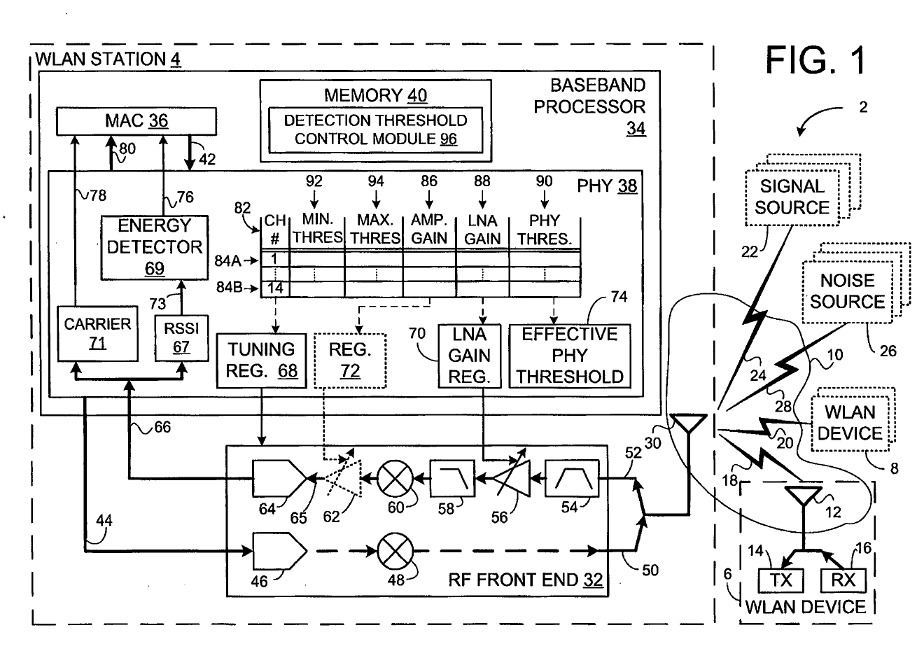

FIG. 1 is a simplified block-diagram illustration of an exemplary wireless communication system 2, in accordance with some embodiments of the invention. Wireless communication system 2 may include a wireless local area network (WLAN) station 4 and a WLAN device 6, and may optionally include one or more WLAN devices 8. WLAN devices 6 and 8 may be, for example, access points (AP) or stations.

WLAN station 4 and WLAN devices 6 and 8 may meet the following standards and/or other existing or future related standards, although this is a non-exhaustive list:
ANSI/IEEE standard 802.11 for Wireless LAN Medium Access Control (MAC) and Physical layer (PHY) specifications:
   Rev. a for Higher-speed physical layer extension in the 5 gigaHertz (GHz) band, published 1999,
   Rev. b for Higher-speed physical layer extension in the 2.4 GHz band, published 1999,
   Rev. g for Higher data rate extension in the 2.4 GHz band, published 2003.

WLAN station 4 and WLAN devices 6 and 8 may be suitable to communicate with one another over a wireless medium 10 in accordance with a particular WLAN standard, such as, for example, ANSI/IEEE standard 802.11 Rev. g (“802.1 μg”). Although the following description refers to definitions of 802.11g, it will be obvious to those skilled in the art how to modify the following for other WLAN standards.

Standards for WLAN, such as, for example, 802.11g, may define a transmission spectrum mask for signals transmitted by transmitters and a minimum energy detection threshold for receivers.

For example, 802.11g defines that the transmission spectral density shall be 0 dBr (decibels relative to the maximum spectral density of the signal) at bandwidth of no more than 18 MHz around a carrier frequency of a transmitted signal, a −20 dBr spectral density at an 11 MHz frequency offset from the carrier frequency, a −28 dBr spectral density at a 20 MHz frequency offset from the carrier frequency, and a −40 dBr spectral density at a 30 MHz or greater frequency offset from the carrier frequency.

Moreover, 802.11g defines an energy detection threshold of −86 dB (Decibel) for receivers in an environment of additive white Gaussian noise (AWGN) and no additional interference. In other words, a receiver compliant with 802.11g should detect signals having energy level of at least −86 dB in an environment of AWGN.

In addition, standards for WLAN may define several alternative communication channels to be used by WLAN devices to communicate with one other. 802.1 μg, for example, defines fourteen overlapping communication channels having carrier frequencies that are spread over the spectrum in 5 megaHertz (MHz) increments in the 2.4 GHz Federal Communication Commission (FCC) defined Industrial, Scientific and Medical (ISM) band.

WLAN device 6 may include one or more antennae 12, and may include a transmitter (Tx) 14 and a receiver (Rx) 16, both coupled to antennae 12. WLAN device 6 may be able to transmit a signal 18, compliant with 802.11g, into wireless medium 10, and of receiving signals from wireless medium 10.

Similarly, WLAN devices 8 may include one or more antennae, receivers and transmitters (not shown), and may be able to transmit respective signals 20, compliant with 802.11g, into wireless medium 10, and to receive signals from wireless medium 10.

WLAN system 2 may optionally include one or more signal sources 22 capable of transmitting respective signals 24 into wireless medium 10, and signals 24 may not be compliant with 802.11g. In addition, WLAN system 2 may include one or more noise sources 26 capable of generating respective noise signals 28, such as, for example, white noise signals, in wireless medium 10.

WLAN station 4 may include one or more antennae 30, a radio frequency (RF) front-end 32 coupled to antennae 30, and a baseband processor 34 coupled to RF front-end 32. Baseband processor 34 may include a medium access controller (MAC) 36, a physical layer controller (PHY) 38, and a memory 40.

Baseband processor 34 and RF front-end 32 may form, at least in part, a transceiver through which WLAN station 4 may be able to transmit signals compliant with 802.11g into wireless medium 10, and may be capable of receiving signals from wireless medium 10.

For example, PHY 38 may receive communication frames 42 from MAC 36 and may send respective digital signals 44 to a digital-to-analog converter (DTA) 46. DTA 46 may convert digital signals 44 into respective analog signals that may be up-converted to an RF frequency by an up-converter 48, and may be sent to antennae 30 via conductors 50. The analog signals generated by DTA 46 may be filtered, shaped, amplified, conditioned and/or attenuated, for example, before being transmitted by antennae 30.

Antennae 30 may receive signals 18, 20, 24 and 28 from wireless medium 10, and may forward replications of signals 18, 20, 24 and 28 to RF front-end 32 over, for example, one or more conductors 52. RF front-end 32 may contain, for example, a band-pass filter 54, a low noise amplifier (LNA) 56, a low-pass filter 58, a down-converter 60, an optional variable gain amplifier 62 and an analog-to-digital converter (ATD) 64. Other configurations of RF front-end 32 are possible.

Replications of signals 18, 20, 24 and 28 received over conductors 52 may be filtered by band-pass filter 54, amplified by LNA 56 and filtered again, by low-pass filter 58. Down-converter 60 may include one or more down-converting stages, and may down convert signals received from low-pass filter 58 into a baseband frequency, optionally, by first down converting the signals into an intermediate frequency and then down converting the intermediate frequency signals into the baseband frequency. The output signals of down-converter 60 may optionally be amplified by optional variable gain amplifier 62 to generate signals 65. Signals 65 may be converted by ATD 64 into a digital output 66 of RF front-end 32.

PHY 38 may be able to tune RF front-end 32 to selected communication channels according to the content of a tuning register 68. While RF front-end 32 is tuned to a selected one of the communication channels, signals transmitted from antenna 30 may have a carrier frequency substantially equal to the carrier frequency defined for the selected communication channel in the 802.1 μg specifications.

In addition, while RF front-end 32 is tuned to a selected one of the communication channels, digital output 66 may originate from signals 18, 20, 24 and 28 having frequencies in a predetermined frequencies band around the carrier frequency defined for the selected communication channel in the 802.1 μg specifications.

LNA 56 may have several possible gains, for example, three possible gains, and PHY 38 may be able to select an active gain of LNA 56 according to the content of an LNA gain register 70. In addition, optional variable gain amplifier 62 may have several possible gains and PHY 38 may be able to select an active gain of optional variable gain amplifier 62 according to the content of an optional register 72. Moreover, PHY 38 may have an effective energy detection threshold, defined by an effective PHY detection threshold register 74.

An active energy detection threshold of WLAN station 4 may be defined, at least in part, by the gains of LNA 56 and optional variable gain amplifier 62, and by the effective energy detection threshold of PHY 38.

For example, the three exemplary possible gains of LNA 56 may correspond to active energy detection thresholds of, for example, −90 dB, −80 dB and −70 dB. Optional variable gain amplifier 62 may have selectable gains in a range of, for example, 0 dB to 5 dB, and an effective energy detection threshold of PHY 38 may be set in a fine granularity in a range of, for example, 0 dB to +12 dB. Consequently, by setting values of LNA gain register 70, a register 72 and effective PHY detection threshold register 74, PHY 32 may set the active energy detection threshold of WLAN station 4 to values in a range of −95 dB to −63 dB.

PHY 32 may include a Received Signal Strength Indication (RSSI) module 67, an energy detector module 69 and a carrier sensing module 71. RSSI module 67, energy detector module 69 and carrier sensing module 71 may each independently be a software module, a hardware module or a hybrid software-hardware module.

RSSI module 67 may receive samples of digital output 66, may calculate powers of the samples and may output a RSSI 73 that may indicate the powers of the samples. Energy detector module 69 may receive RSSI 73 and may extract the energy of the samples from RSSI 73 and possibly other input (not shown). If the energy level of signals 65 is higher than the active energy detection threshold of WLAN station 4, energy detector module 69 may assert a channel-busy indication 76 to MAC 36.

Carrier sensing module 71 may receive digital output 66 and may perform operations, such as, for example, correlations, on digital output 66 in order to sense whether digital output 66 contains 802.11a-compatible carrier information. If carrier sensing module 71 senses 802.11a-compatible carrier information in digital output 65, carrier sensing module 71 may assert a carrier-sense indication 78 to MAC 36.

If both channel-busy indication 76 and carrier-sense indication 78 are asserted, PHY 38 may extract extracted-information 80 from digital output 65 and may send extracted-information 80 to MAC 36. MAC 36 may recognize that both channel-busy indication 73 and carrier-sense indication 71 are asserted, may sample extracted-information 80 and may demodulate communication frames from extracted-information 80.

In the following description, a received signal is said to be “recognized” by WLAN station 4 if PHY 38 asserts carrier-sense indication 78 in response to receiving the signal.

PHY 38 may store a programmable access point (AP) table 82. AP table 82 may contain fourteen records 84, one for each communication channel. A record 84 may include fields 86, 88, and 90, to hold values corresponding to a preferred gain of optional variable gain amplifier 62, a preferred gain of LNA 56 and a preferred energy detection threshold of PHY 38, respectively. Values held in fields 86, 88, and 90 of a record 84 may represent a preferred energy detection threshold of WLAN station 4 for the corresponding communication channel. A record 84 may also include fields 92 and 94 to store values corresponding to a minimal signal recognition threshold and a maximal signal recognition threshold, respectively. Fields 92 and 94 are described in further detail hereinbelow.

In order to tune RF front-end 32 to the specific communication channel, PHY 38 may write a value corresponding to the specific communication channel to tuning register 68. In addition, PHY 38 may set an active energy detection threshold of WLAN station 4 for the tuned communication channel by writing values fetched from fields 86, 88, and 90 of the corresponding record 84 in register 72, LNA gain register 70 and effective PHY detection threshold register 74, respectively.

In the following description, while a first WLAN device tries to recognize a signal originating from a second WLAN device, that signal is referred to as a “target signal”, and its source is referred to as a “target source”. In addition, signals that are not the target signal are referred to as “interfering signals”, their energies are referred to as “interfering energies”, and their sources are referred to as “interference sources”.

For example, WLAN device 6 may be a target source for WLAN station 4, and WLAN devices 8, signal sources 22 and noise sources 26 may be interference sources for WLAN station 4, as signals 20, 24 and 28 may interfere with proper recognition of signal 18 by WLAN station 4. The energy of a received signal may decrease as the distance from the transmission source increases. Since the relative locations of WLAN devices 4, 6 and 8, signal sources 22 and noise sources 26 may vary dynamically, the energy levels of signals 18, 20, 24 and 28, as received by receiver 34, may vary dynamically.

It may be appreciated that at an active energy detection threshold of, for example, −95 dB, WLAN station 4 may be able to recognize target signals from farther distances than at an active energy detection threshold of, for example, −85 dB. However, the same principle is applicable to interfering signals, thus selecting an active energy detection threshold may involve a trade off between energy levels of target signals and interfering signals.

Memory 40 may store a detection threshold control module 96 to be executed by PHY 38 for dynamically adapting the active energy detection threshold of WLAN station 4.

In the following description, a pair of WLAN devices are denoted “associated” if an associating stage of establishing a mutual communication link between them over a particular communication channel is successfully completed, and each of the associated WLAN devices is denoted to be in an “associated state” regarding that particular channel.

In addition, in the following description, a WLAN device that is not associated with another WLAN device over a particular communication channel, is denoted to be in an “unassociated state” regarding that particular communication channel, and a WLAN device that is trying to associate another WLAN device over a particular communication channel is denoted to be in an “associating state” regarding that particular communication channel.

For WLAN station 4 to recognize target signal 18, the energy of target signal 18, as received by WLAN station 4, may have to be higher than the interfering energies of signals 20, 24 and 28, as received by WLAN station 4. Otherwise, the energy of target signal 18 may be masked by the energies of signals 20, 24 and 28, and target signal 18 may not be detectable or may not be recognizable by WLAN station 4.

Signals 20 may interfere with reception of target signal 18 by WLAN station 4 if signals 20 are transmitted over the same communication channel as target signal 18, and the relative locations of WLAN devices 4, 6 and 8 are such that the energies of signals 20 mask or corrupt target signal 18, as received by WLAN station 4.

However, signals 20 may interfere with target signal 18 even if signals 20 are transmitted over communication channels that are separated by less than 25 MHz from the communication channel used by target signal 18. Due to the definition of the transmission spectral mask in 802.11g, interfering energy may leak from one channel to the other, and the relative locations of WLAN devices 4, 6 and 8 may be such that the leaking energies of signals 20 may mask or corrupt target signal 18, as received by WLAN station 4.

For receivers having an energy detection threshold as defined in 802.11g for an environment of AWGN, i.e. −86 dB, it may be suitable to use channels that are 25 MHz apart, such as, for example, channels 1 and 6, for collocated WLAN transmissions with a minimal risk of mutual interference. However, for receivers having lower energy detection thresholds, such as, for example, −95 dB, the risk for energy from channel 1 to interfere with signals at channel 6, for example, is higher.

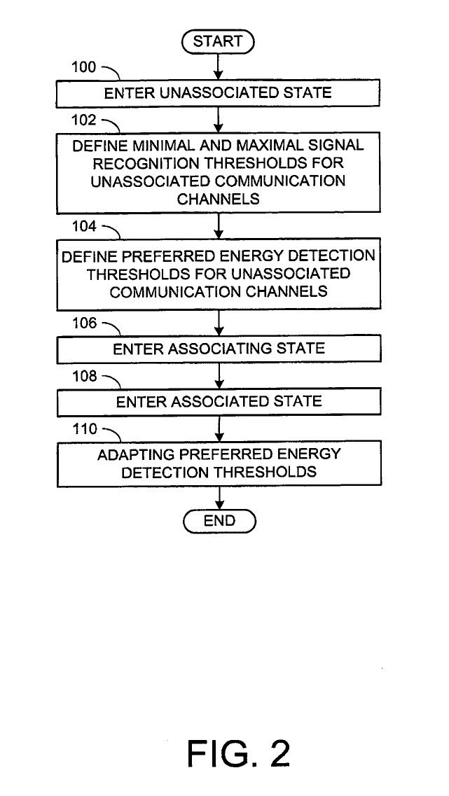

Reference is made now in addition to FIG. 2, which is a simplified flowchart illustration of an exemplary method for dynamic adaptation of active energy detection threshold of WLAN station 4, according to some embodiments of the invention.

WLAN station 4 may implement the method described in FIG. 2 in order to recognize other WLAN devices in its vicinity, and to establish and maintain communication links with at least a subset of the recognized WLAN devices.

At the beginning of the method, WLAN station 4 may be in an “unassociated state” regarding one or more communication channels (100). WLAN station 4 may scan unassociated communication channels, and for a scanned unassociated communication channel, module 96 may define energy detection thresholds referred to as the “maximal signal recognition threshold” and “minimal signal recognition threshold”, between which WLAN station 4 can recognize 802.11 g compatible signals originating from other WLAN devices (102). Module 96 may store the maximal signal recognition threshold and minimal signal recognition threshold of an unassociated communication channel in the fields 92 and 94, respectively, of the record 84 corresponding to that communication channel.

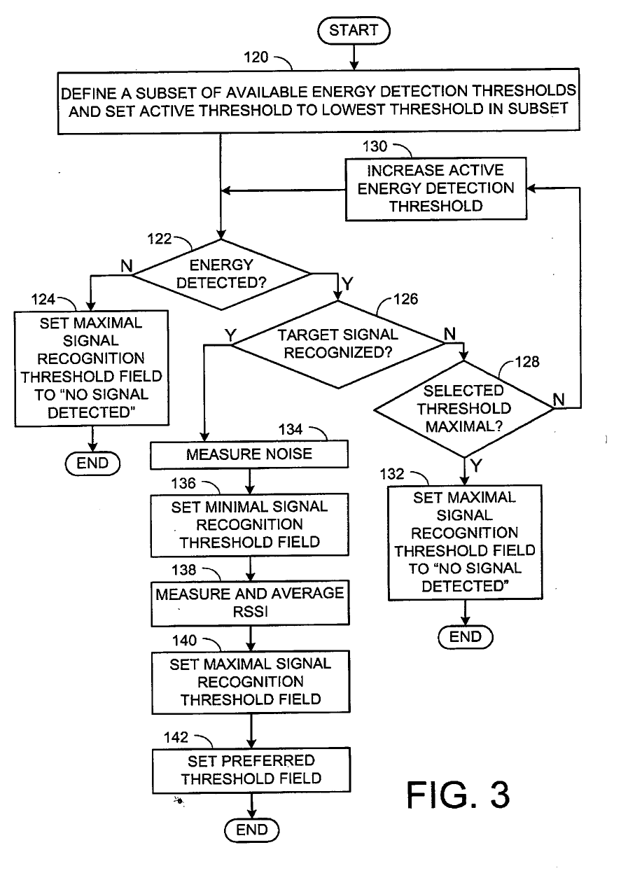

For the purpose of recognizing other WLAN devices, WLAN station 4 may, for example, transmit predefined probing requests and may wait for other WLAN devices to respond by transmitting predefined messages. Alternatively, WLAN station 4 may monitor unassociated communication channels for predefined beacon signals transmitted by other WLAN devices. An exemplary method of box (102) for one unassociated communication channel is provided in FIG. 3.

For communication channels for which maximal and minimal signal recognition thresholds are defined in box (102), module 96 may define preferred energy detection thresholds, and may store corresponding values in fields 86, 88, and 90 of the corresponding record 84 (104). In box (104), module 96 may avoid selecting gains of LNA 56 that may saturate LNA 56, and may avoid selecting gains of optional variable gain amplifier 62 that may saturate optional variable gain amplifier 62.

WLAN station 4 may enter an associating state (106), in which WLAN station 4 may try to associate WLAN devices that were recognized in box (102).

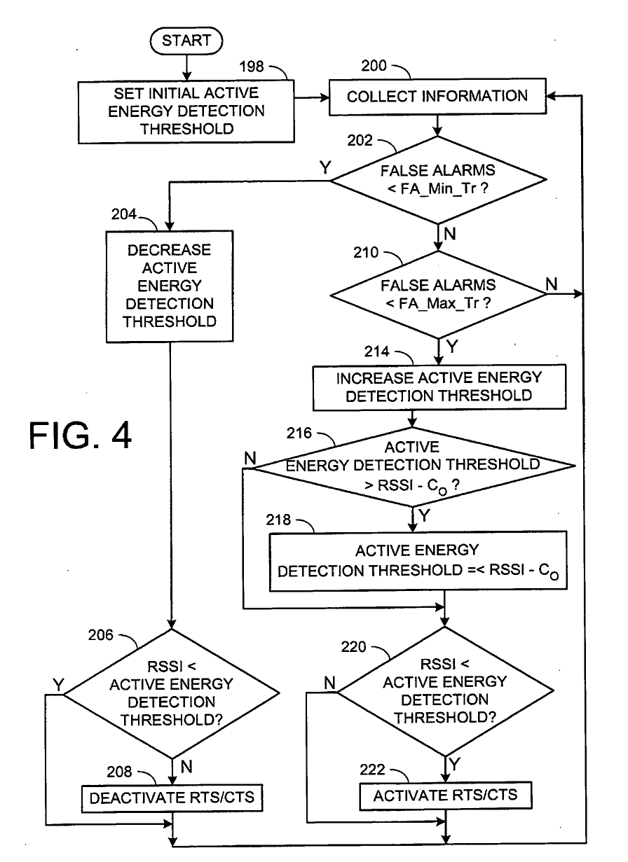

After association of WLAN station 4 with one or more other WLAN devices, WLAN station 4 may enter an associated state (108), and module 96 may adapt the active energy detection thresholds of WLAN station 4 for associated communication channels (110) in response to, for example, changes in the received energy levels of interfering signals and target signals. An exemplary method for box (110) is provided in FIG. 4.

Reference is made now in addition to FIG. 3, which is a simplified flowchart illustration of an exemplary method for defining minimal and maximal signal recognition thresholds of WLAN station 4 for an unassociated communication channel, according to some embodiments of the invention.

The method of FIG. 3 is described in an exemplary relation to channel 1 and a respective record 84A. It will be obvious to those skilled in the art how to modify the method of FIG. 3 for any other communication channel.

Module 96 may define a subset of available energy detection thresholds of WLAN station 4, for example, {−95 dB, −90 dB, −85 dB, −80 dB, −70 dB}, and module 96 may select an active energy detection threshold by writing to LNA gain register 70, register 72 and effective PHY threshold register 74 values corresponding to the lowest available energy detection threshold in the subset, e.g. −95 dB. (120).

Module 96 may monitor detection of energy by PHY 38 at communication channel 1 (122). If no energy is detected by PHY 38, this means that the active energy detection threshold of WLAN station 4 is higher than energies of surrounding interfering signals and no target signal is received. Module 96 may store a value corresponding to “no WLAN signal detected” in field 94 (124) and may terminate.

However, if energy is detected, PHY 38 may try to recognize a target signal (126). If a target signal is not recognized, the detected energy may be from interference sources, and if the active energy detection threshold is not the highest available energy detection threshold in the subset (128), module 96 may select the next higher available energy detection threshold in the subset (130), and may repeat the sequence (122), (126), (128) and (130) until a target signal is recognized in box (126) or until the active energy detection threshold is the highest available energy detection threshold in the subset (128).

If no target signal is recognized in box (126), and the active energy detection threshold is the highest available energy detection threshold in the subset, e.g. −70 dB (128), module 96 may store a value corresponding to “no WLAN signal detected” in field 94 (132) and may terminate.

If a target signal is detected in box (126), module 96 may measure the noise level in channel 1, for example, between frames of the target signal (134). Module 46 may add a constant, for example, 3 dB, to the detected noise level, and may store the result in field 92 (136). Module 96 may average RSSI indication 73 over, for example, 100 frames in the target signal (138) and may store in field 94 a value corresponding to the averaged RSSI minus a margin constant of, for example, 5 dB (140).

Module 96 may select a preferred energy detection threshold based on the values of fields 92 and 94 (142), and may store corresponding values in fields 86, 88 and 90. For example, the preferred energy detection threshold may be selected to be substantially equal to the minimal signal recognition threshold, or to be substantially equal to an average of the minimal and maximal signal recognition thresholds. However, module 96 may avoid selecting a gain of LNA 56 that may saturate LNA 56, and may avoid selecting a gain of optional variable gain amplifier 62 that may saturate optional variable gain amplifier 62. The method may then terminate.

Reference is made now to FIG. 4, which is a simplified flowchart illustration of an exemplary method for dynamic adaptation of an active energy detection threshold of a receiver in WLAN station 4 for an associated communication channel, according to some embodiments of the invention.

Although the method of FIG. 4 is described in relation to an exemplary WLAN configuration, it will be obvious to those skilled in the art how to modify the method of FIG. 4 for any other WLAN configuration. When the method of FIG. 4 is initiated, WLAN station 4 is associated with WLAN device 6 over communication channel 1, and optionally, some or all of WLAN devices 8 are associated with WLAN station 4 over other communication channels.

PHY 38 may set an initial active energy detection threshold by storing the values of fields 86, 88 and 90 in register 72, LNA gain register 70 and effective PHY threshold register 74, respectively (198).

PHY 38 may collect information regarding communication channel 1 (200). Such information may be, for example, the RSSI of frames of target signal 18 from WLAN device 6, the RSSI of frames of signals 20 from WLAN devices 8 that are associated with WLAN station 4, and the RSSI of signals originating from interference sources, such as, for example, signal sources 22, noise sources 26 and WLAN devices 8 that are not associated with WLAN station 4.

In addition, or alternatively, PHY 38 may collect information regarding detected “false alarms”. A false alarm may be defined, for example, as an event in which PHY 38 detects energy received over communication channel 1 but is unable to recognize target signal 18 in that energy. Recognition of target signal 18 may rely on, for example, recognition of valid preambles and/or physical layer headers in target signal 18. The percentage of false alarms may be defined, for example, as the number of times a non valid preamble and/or a non valid physical layer header is detected, divided by the number of times energy is detected.

In the following description, decisions in boxes (202) and (210) are made according to detected false alarms. However, it may be appreciated that decisions in boxes (202) and (210) may be made according to other criteria, such as, for example, detected noise levels and detected percentage of time in which energy is detected by PHY 38 but a carrier signal is not sensed. It may be appreciated that it will be obvious to those skilled in the art how to modify the method described in FIG. 4 accordingly.

The method may compare the number of detected false alarms to a predefined minimal false alarm threshold FA_Min_Tr (202). If the number of detected false alarms is lower than the minimal false alarm threshold FA_Min_Tr, PHY 38 may decrease the active energy detection threshold (204). However, PHY 38 may not decrease the active energy detection threshold to below a minimum limit, that may be, for example, the value stored in field 92.

In addition, PHY 38 may check if according to the information collected in box (200), or according to other information, there are frames of any of the associated WLAN devices having an RSSI that is lower than the active energy detection threshold (206). If there are no such frames, PHY 38 may deactivate use of a request-to-send/clear-to-send (RTS/CTS) protocol [Danny, in FIG. 4, boxes 208 and 222 you wrote “CTS/RTS” and not “RTS/CTS”. It should be consistent.] in the communication between WLAN station 4 and associated WLAN devices, if such a protocol is in use (208). The method may then continue from box (200).

If the number of detected false alarms is higher than the minimal false alarm threshold FA_Min_Tr (202) and lower than a predefined maximal false alarm threshold FA_Max_Tr (210), PHY 38 may increase the active energy detection threshold (214). However, if the incremented active energy detection threshold is higher than the measured RSSI of signal 18 (216), PHY 38 may correct the active energy detection threshold to be lower than the RSSI of signal 18 (218). According to some other embodiments of the invention, in box (216), PHY 38 may check that the incremented active energy detection threshold plus a margin constant C₀ of, for example, 10 dB, is higher than the measured RSSI of signal 18, and in box (218) PHY 38 may correct the active energy detection threshold to be lower than the RSSI of signal 18 minus that margin constant C₀.

In addition, PHY 38 may check if according to the information collected in box (200), or according to other information, there are frames of any of the associated WLAN devices having a RSSI that is lower than the active energy detection threshold (220). If there are any such frames, the method may activate use of RTS/CTS protocol in the communication between WLAN station 4 and associated WLAN devices, if such a protocol is not in use (222). The method may then continue from box (200).

A non-exhaustive list of examples for antennas 12 and 30 includes dipole antennas, monopole antennas, loop antennas, shot antennas, dual antennas, omni-directional antennas or any other suitable antennas.

A non-exhaustive list of examples for WLAN station 4 and WLAN devices 6 and 8 includes a WLAN mobile unit, a WLAN stationary unit, a WLAN add-on card, a WLAN personal computer memory card international association (PCMCIA) card, a WLAN personal computer (PC) card, a WLAN switch, a WLAN router, a WLAN server, a game console, a digital camera, a digital video camera, a television set, a desktop personal computer, a work station, a server computer, a laptop computer, a notebook computer, a hand-held computer, a personal digital assistant (PDA), and the like.

A non-exhaustive list of examples for baseband processor 34 includes a central processing unit (CPU), a digital signal processor (DSP), a reduced instruction set computer (RISC), a complex instruction set computer (CISC) and the like. Moreover, processor 38 may be part of an application specific integrated circuit (ASIC) or may be a part of an application specific standard product (ASSP).

A non-exhaustive list of examples for memory 40 includes any combination of the followings: registers, latches, read only memory (ROM), mask ROM, synchronous dynamic random access memory (SDRAM), static random access memory (SRAM), flash memory, and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. A method comprising:
adjusting an active energy detection threshold of a wireless local area network device to changing conditions of a wireless local area network.

2. The method of claim 1, wherein adjusting said active energy detection threshold includes:
adjusting a gain of a low noise amplifier of said wireless local area network device.

3. The method of claim 1, further comprising:
adjusting an effective energy detection threshold of a physical layer controller of said wireless local area network device.

4. The method of claim 1, wherein said wireless local area network device is tunable to any communication channel from a set of communication channels and adjusting said active energy detection threshold includes:
independently adjusting said active energy detection threshold for any of said communication channels.

5. The method of claim 1, wherein adjusting said active energy detection threshold includes:
selecting said active energy detection threshold from a predefined range of energy detection thresholds.

6. The method of claim 1, further comprising:
counting a number of false alarms; and
decreasing said active energy detection threshold if said number is lower than a first false alarm threshold.

7. The method of claim 6, further comprising:
increasing said active energy detection threshold if said number is higher than said first false alarm threshold and lower than a second false alarm threshold.

8. The method of claim 6, further comprising:
deactivating a request-to-send/clear-to-send protocol in communication of said wireless network device if received signal strength indications of all signals received by said wireless local area network device from associated wireless local area network devices meet or exceed said active energy detection threshold.

9. The method of claim 8, further comprising:
activating a request-to-send/clear-to-send protocol in communication of said wireless local area network device if a received signal strength indication of at least one signal received from one of said associated wireless local area network devices by said wireless local area network device is lower than said active energy detection threshold.

10. A method comprising:
determining preferred energy detection thresholds for a receiver of a first wireless local area network device for corresponding communication channels to which said receiver is tunable.

11. The method of claim 10, further comprising:
selecting one of said preferred energy detection thresholds as an active energy detection threshold of said receiver for communication on a corresponding one of said communication channels.

12. The method of claim 11, further comprising:
adjusting said active energy detection threshold during said communication.

13. The method of claim 10, further comprising:
determining for a particular communication channel a maximal signal recognition threshold and a minimal signal recognition threshold between which a wireless local area network signal is recognized by said receiver,
wherein said preferred energy detection threshold for said particular communication channel does not exceed said maximal signal recognition threshold and is not less than said minimal signal recognition threshold.

14. An article comprising a storage medium having stored thereon instructions that, when executed by a computing platform, result in:
adjusting an active energy detection threshold of a wireless local area network device to changing conditions of a wireless local area network.

15. The article of claim 14, wherein a receiver of said wireless local area network device is tunable to any communication channel from a range of communication channels and adjusting said active energy detection threshold includes:
independently adjusting said active energy detection threshold for any of said communication channels.

16. The article of claim 14, wherein executing said instructions further results in:
counting a number of false alarms; and
decreasing said active energy detection threshold if said number is lower than a first false alarm threshold.

17. An article comprising a storage medium having stored thereon instructions that, when executed by a computing platform, result in:
determining preferred energy detection thresholds for a receiver of a first wireless local area network device for corresponding communication channels to which said receiver is tunable.

18. The article of claim 17, wherein executing said instructions further results in:
selecting one of said preferred energy detection thresholds as an active energy detection threshold of said receiver for communication on a corresponding one of said communication channels.

19. The article of claim 18, wherein executing said instructions further results in:
adjusting said active energy detection threshold during said communication.

20. A wireless local area network device comprising:
a receiver that is tunable to any communication channel from a set of communication channels, said receiver including at least:
a radio frequency front-end; and
a processor having a physical layer controller,
wherein said processor is to adjust an active energy detection threshold of said receiver independently for any of said communication channels.

21. The wireless local area network device of claim 20, wherein said processor is to determine preferred energy detection thresholds for said receiver for said communication channels.

22. The wireless local area network device of claim 20, wherein said processor is to adjust said active energy detection threshold at least in part by adjusting an effective energy detection threshold of said physical layer controller.

23. The wireless local area network device of claim 20, wherein said front-end further includes a low noise amplifier, and said processor is to adjust said active energy detection threshold at least in part by adjusting a gain of said low noise amplifier.

24. The wireless local area network device of claim 20, wherein said wireless local area network device is a station.

25. The wireless local area network device of claim 20, further comprising:
a monopole antenna coupled to said receiver.

26. A wireless local area network system comprising:
a first wireless local area network device; and
a second wireless local area network device to communicate with said first wireless local area network device, said second wireless local area network device comprising:
a receiver that is tunable to any communication channel from a set of communication channels, said receiver including at least:
a radio frequency front-end; and
a processor having a physical layer controller,
wherein said processor is to adjust an active energy detection threshold of said receiver independently for any of said communication channels.

27. The wireless local area network system of claim 26, wherein said processor is to determine preferred energy detection thresholds for said receiver for said communication channels.

28. The wireless local area network system of claim 26, wherein said processor is to adjust said active energy detection threshold at least in part by adjusting an effective energy detection threshold of said physical layer controller.

29. The wireless local area network system of claim 26, wherein said front-end further includes a low noise amplifier, and said processor is to adjust said active energy detection threshold at least in part by adjusting a gain of said low noise amplifier.

30. The wireless local area network system of claim 26, wherein said second wireless local area network device is a station.
